(19) United States
(12) Patent Application Publication
(10) Pub. No.: US 2026/0167234 A1
(43) Pub. Date: Jun. 18, 2026

(54) METHOD AND APPARATUS FOR PREDICTING A PATH OF A TARGET

(71) Applicants: HYUNDAI MOTOR COMPANY, Seoul (KR); KIA CORPORATION, Seoul (KR)

(72) Inventor: Sung Wook Lee, Hwaseong-si (KR)

(73) Assignees: HYUNDAI MOTOR COMPANY, Seoul (KR); KIA CORPORATION, Seoul (KR)

(21) Appl. No.: 19/336,440

(22) Filed: Sep. 22, 2025

(30) Foreign Application Priority Data
Dec. 18, 2024 (KR) 10-2024-0190043

(51) Int. Cl. B60W 60/00; B60W 40/04; B60W 50/00

(52) U.S. Cl. CPC B60W 60/00272; B60W 40/04; B60W 50/0097; B60W 2050/0056; B60W 2520/14; B60W 2540/18; B60W 2554/4041; B60W 2554/4042; B60W 2554/4043; B60W 2554/4044; B60W 2554/801

(57) ABSTRACT

A method for predicting a path of a target includes receiving driving information of an ego vehicle, driving information of the target, and a predicted path of the ego vehicle. The predicted path of the ego vehicle is a sequence of points representing positions and directions of the ego vehicle at each prediction time. The method further includes determining whether the target is driving relative to a path of the ego vehicle based on the driving information of the ego vehicle and the target. The method further includes generating a virtual lane based on the predicted path of the ego vehicle. The method further includes generating a predicted path of the target based on the virtual lane.

### CROSS-REFERENCE TO RELATED APPLICATION

This application claims the benefit of and priority to Korean Patent Application No. 10-2024-0190043, filed on Dec. 18, 2024 in the Korea Intellectual Property Office, the entire contents of which are incorporated herein by reference.

### TECHNICAL FIELD

The present disclosure relates to a method and an apparatus for predicting a path of a target. More particularly, the present disclosure relates to a method and an apparatus for improving path prediction accuracy by using the path of an ego vehicle when predicting a path for a target in a situation where the ego vehicle may not obtain map information and/or lane information.

### BACKGROUND

The statements in this section merely provide background information related to the present disclosure and do not necessarily constitute prior art.

An autonomous vehicle needs to predict the future path of an object (target) around the autonomous vehicle for path planning, a collision avoidance decision, etc. For example, when there is an object such as other vehicles, pedestrians, and personal mobility devices around the autonomous vehicle, the autonomous vehicle should predict the future path of the target and should warn a driver or take evasive action before a collision occurs.

The related art utilizes the target's driving information (speed, direction, position, etc.) and map information or lane information to predict the path of a target vehicle driving on a road. Because the target driving on the road generally drives along a lane, the related art predicts the target's path based on map information or lane information of an area in which an ego vehicle and the target are driving.

However, the related art has limitations in that it is difficult to accurately predict the target's path when the map information or the lane information may not be utilized. Assuming that the yaw rate of the target is ignored on a curved road or an intersection and the target is driving straight in a current driving direction, a predicted path will deviate significantly from an actual future path of the target. Among conventional technologies, there is a technology for generating turning information based on the amount of change in the heading angle of the target and predicting the path of the target. However, this is problematic in that the error of the target's heading angle caused by sensor recognition error is large, leading to significant distortion in a turning amount.

Therefore, a technology capable of accurately predicting the target's path is needed, even in the case where map information and lane information are unavailable or inaccurate (e.g., outdated map information and rainy conditions where it is difficult for a sensor to recognize a lane).

### SUMMARY

In view of the above, the present disclosure provides a method and an apparatus capable of improving path prediction accuracy by predicting the path of a target based on the path of an ego vehicle, even in the case where map information and lane information are unavailable when predicting a path for the target.

The present disclosure provides a method and an apparatus capable of predicting the path of a target with a small computational amount and memory usage.

Technical objects to be achieved by the present disclosure are not limited to those described above, and other technical objects not mentioned above may also be clearly understood from the present disclosure by those having ordinary skill in the art to which the present disclosure belongs.

An embodiment of the present disclosure provides a method for predicting a path of a target. The method includes receiving driving information of an ego vehicle, driving information of the target, and a predicted path of the ego vehicle. The predicted path of the ego vehicle is a sequence of points representing positions and directions of the ego vehicle at each prediction time. The method further includes determining whether the target is driving relative to a path of the ego vehicle based on the driving information of the ego vehicle and the target. The method includes generating a virtual lane based on the predicted path of the ego vehicle. The method includes generating a predicted path of the target based on the virtual lane.

Another embodiment of the present disclosure provides an apparatus for predicting a path of a target. The apparatus includes at least one memory configured to store commands; and at least one processor. The at least one processor is configured, by executing the commands, to receive driving information of an ego vehicle, driving information of the target, and a predicted path of the ego vehicle. The predicted path of the ego vehicle is a sequence of points representing positions and directions of the ego vehicle at each prediction time. The at least one processor is further configured to determine whether the target is driving relative to a path of the ego vehicle based on the driving information of the ego vehicle and the target. The at least one processor is further configured to generate a virtual lane based on the predicted path of the ego vehicle. The at least one processor is further configured to generate a predicted path of the target based on the virtual lane.

According to an embodiment of the present disclosure, it is possible to improve path prediction accuracy by predicting the path of a target based on the path of an ego vehicle, in the case where map information and lane information are unavailable when predicting a path for the target.

According to an embodiment of the present disclosure, it is possible to predict the path of a target with a small computational amount and memory usage, by creating a virtual lane using a spline curve.

According to an embodiment of the present disclosure, it is possible to perform path prediction even for a target located outside a path prediction section of an ego vehicle, by creating a virtual lane using a spline curve.

The advantageous effects of the present disclosure are not limited to those described above, and other advantageous effects of the present disclosure not mentioned above may be understood clearly by those having ordinary skill in the art from the descriptions given below.

### BRIEF DESCRIPTION OF THE DRAWINGS

FIG. 1 is a block diagram schematically showing a path generating device according to an embodiment of the present disclosure.

FIG. 2 is a flowchart schematically illustrating a process in which the path generating device according to an embodiment of the present disclosure generates a predicted path of a target.

FIG. 3 is a diagram illustrating an example of a method in which the path generating device determines whether the target is driving relative to the path of an ego vehicle, according to an embodiment of the present disclosure.

FIG. 4 is a diagram illustrating an example of a method in which the path generating device generates a virtual lane using the predicted path of the ego vehicle, according to an embodiment of the present disclosure.

FIGS. 5-13 are diagrams illustrating a process in which the path generating device predicts a target's path using the virtual lane, according to an embodiment of the present disclosure.

FIGS. 14, 15, and 16 illustrate examples demonstrating improved path prediction performance achieved by a method according to an embodiment of the present disclosure.

FIG. 17 is a flowchart illustrating a process in which the path generating device extends the predicted path of the target, according to an embodiment of the present disclosure.

FIG. 18 is a diagram illustrating an example of the extended predicted path of the target, according to an embodiment of the present disclosure.

FIGS. 19, 20, and 21 illustrate examples of a situation in which extension of a prediction time window of a target is required according to an embodiment of the present disclosure.

FIG. 22 is a block diagram schematically illustrating a computing device that may be used to implement a method or an apparatus according to an embodiment of the present disclosure.

### DETAILED DESCRIPTION

Hereinafter, some embodiments of the present disclosure are described in detail with reference to the accompanying drawings. In the present disclosure, like reference numerals designate like elements, although the elements are shown in different drawings. Further, in the present disclosure, a detailed description of known functions and configurations incorporated therein has been omitted for the purpose of clarity and for brevity.

Additionally, various terms such as first, second, A, B, (a), (b), etc., are used solely to differentiate one component from the other but are not intended to imply or suggest the substances, order, or sequence of the components. Throughout the present disclosure, when a part ‘includes’ or ‘comprises’ a component, the part is meant to further include other components is not intended to exclude thereof unless specifically stated to the contrary. The terms, such as ‘unit’, ‘module’, and the like, refer to one or more units for processing at least one function or operation, which may be implemented by hardware, software, or a combination thereof. When a controller, unit, module, component, device, element, or the like of the present disclosure is described as having a purpose or performing an operation, function, or the like, the controller, unit, module, component, device, element, or the like should be considered herein as being “configured to” meet that purpose or to perform that operation or function. Each controller, unit, module, component, device, element, and the like may separately embody or be included with a processor and a memory, such as a non-transitory computer readable media, as part of the apparatus.

The following detailed description, together with the accompanying drawings, is intended to describe embodiments of the present disclosure and is not intended to represent the only embodiments in which the present disclosure may be practiced.

In the present disclosure, path prediction refers to the function of an autonomous driving system to predict the future path of a target (an object existing around an ego vehicle).

In the present disclosure, a prediction time window refers to a time window from a current time, at which the autonomous driving system attempts to predict the path, to a future time. The length of the prediction time window may be expressed in the unit of time. For example, if the autonomous driving system predicts a path from a current time to a future time 4 seconds later, the length of the prediction time window is 4 seconds.

In the present disclosure, a prediction time interval refers to a time interval during which the autonomous driving system predicts a path. The prediction time interval may be expressed in the unit of time. For example, if the autonomous driving system predicts the path in 0.1-second intervals, the prediction time interval is 0.1 seconds.

In the present disclosure, an ego coordinate is a Cartesian coordinate in which the origin is located at the front of the ego vehicle, the x-axis is parallel to the travel direction of the ego vehicle, and the y-axis is perpendicular to the travel direction of the ego vehicle.

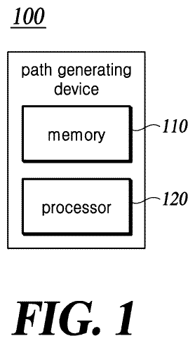

FIG. 1 is a block diagram schematically showing a path generating device 100 according to an embodiment of the present disclosure.

The path generating device 100 includes a memory 110 and a processor 120. The path generating device 100 may be implemented in the form of an embedded device, a server, an electronic device within an autonomous driving system, etc. Not all blocks illustrated in FIG. 1 are essential components, and some blocks included in the path generating device 100 may be added, changed, or deleted in other embodiments. The components illustrated in FIG. 1 represent functionally distinct elements, and one or more components may be implemented to be integrated with each other in an actual physical environment.

The memory 110 stores data and commands required for the operation of the path generating device 100.

The memory 110 may store driving information of the ego vehicle acquired using at least one sensor included in the ego vehicle. The driving information of the ego vehicle may include the velocity, acceleration, steering angle, steering angle velocity, heading angle, yaw rate, etc. of the ego vehicle. In particular, the memory 110 may store a predicted path, or paths, of the ego vehicle. In the present disclosure, the predicted path of the ego vehicle may be expressed as a sequence of points or a point set including the position information and direction information of the ego vehicle at each time.

Further, the memory 110 may store driving information of the target acquired using at least one sensor included in the ego vehicle. The driving information of the target may include the position, velocity, and heading angle of the target. In particular, each of the position, velocity, and heading angle of the target may be a relative position, a relative velocity, and a relative heading angle with respect to the ego vehicle.

The processor 120 controls the overall operation of the path generating device 100. The processor 120 may be implemented with one or more processors. The processor 120 may execute commands stored in the memory 110.

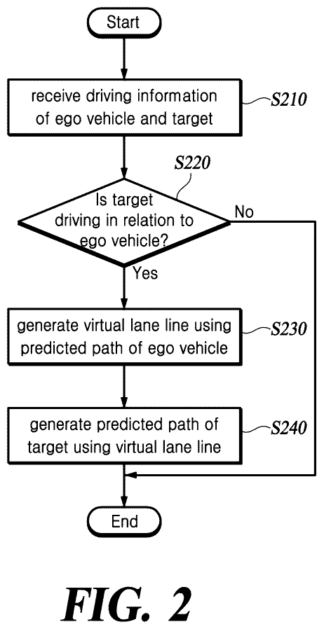

FIG. 2 is a flowchart schematically illustrating a process in which the path generating device 100 according to an embodiment of the present disclosure generates the predicted path of the target.

The path generating device 100 receives driving information of the ego vehicle and driving information of the target, in step S210. The driving information of the ego vehicle includes the predicted path of the ego vehicle, which indicates the position information and direction information of the ego vehicle at each time.

The path generating device 100 determines whether the target is driving relative to the path of the ego vehicle, in step S220. When the target is not driving relative to the path of the ego vehicle (S220-NO), the path generating device 100 terminates the path prediction according to the present disclosure. When the target is driving relative to the path of the ego vehicle (S220-YES), the path generating device 100 generates a virtual lane using the predicted path of the ego vehicle in step S230 and generates the predicted path of the target using the virtual lane in step S240.

Hereinafter, steps S220, S230, and S240 are described in detail.

The path generating device 100 determines whether the target is driving relative to the path of the ego vehicle, in step S220. The expression “the target is driving relative to the path of the ego vehicle” means that the target drives along a path that is identical or similar to the path of the ego vehicle.

The path generating device 100 may determines that the target is driving relative to the path of the ego vehicle, when the change amount ADLₐₜ of the relative lateral distance D_{Lat} between the ego vehicle and the target is equal to or less than a predetermined value and/or the change amount Δθ_{tgt} of the relative heading angle θ_{tgt} of the target is equal to or less than a predetermined value, for a predetermined tracking age or longer. The term “tracking age” refers to time for which the sensor continuously recognizes the target, the term “relative lateral distance” refers to the shortest distance from the turning path of the ego vehicle to the target, calculated based on the steering angle and yaw rate of the ego vehicle, and the term “relative heading angle” refers to a difference between the heading angle of the target and the heading angle of the ego vehicle.

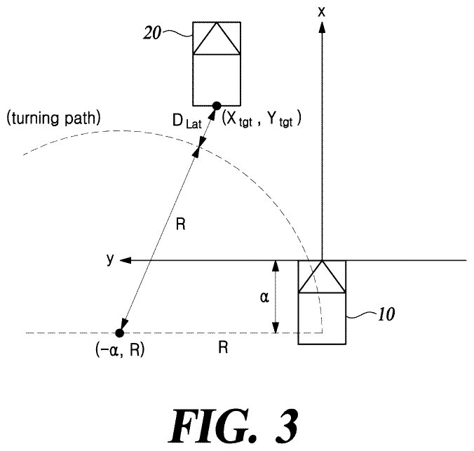

FIG. 3 is a diagram illustrating an example of a method in which the path generating device 100 determines whether the target 20 is driving relative to the path of the ego vehicle 10.

In FIG. 3, (X_{tgt}, Y_{tgt}) are coordinate values indicating the position of the target 20 in the ego coordinate, and (−α, R) are coordinate values indicating the center of the turning path of the ego vehicle 10 calculated based on the steering angle and yaw rate of the ego vehicle 10. a is a distance from the front bumper of the ego vehicle 10 to a rear axle of the ego vehicle 10, and R is the turning radius of the turning path. D_{Lat} represents the shortest distance from the turning path of the ego vehicle 10 to the target 20.

Using well-known geometric principles, the relative lateral distance D_{Lat} may be calculated as shown in Equation 1.

$${D}_{Lat} = \sqrt{{( {X}_{tgt} + α )}^{2} + {( {Y}_{tgt} - R )}^{2}} - R \qquad [ Equation 1 ]$$

The path generating device 100 may calculate a relative lateral distance change amount ΔD_{Lat} from a difference between a relative lateral distance D_{Lat,cur} at current time and a relative lateral distance D_{Lat,pre} at previous time.

Further, the path generating device 100 may calculate a relative heading angle change amount Δθ_{tgt} from a difference between a relative heading angle θ_{tgt,cur} at the current time received from one or more sensors and a relative heading angle θ_{tgt,pre} at the previous time.

In an additional embodiment, the path generating device 100 may use a noise removal filter to minimize the effects of noise included in change amount calculation results. For example, the path generating device 100 may perform low-pass filtering or moving average filtering on the relative lateral distance change amount D_{Lat,cur}−D_{Lat,pre} and/or the relative heading angle change amount θ_{tgt,cur}−θ_{tgt,pre}.

The path generating device 100 may determine that the target 20 is driving relative to the path of the ego vehicle 10, when the tracking age for the target is equal to or greater than a predetermined value and the relative lateral distance change amount ΔD_{Lat} and/or the relative heading angle change amount Δθ_{tgt} are equal to or less than each predetermined value.

When the target is driving relative to the path of the ego vehicle, the path generating device 100 generates a virtual lane using the predicted path of the ego vehicle, in step S220.

In the present disclosure, the predicted path of the ego vehicle is expressed as a point set or a sequence of points that include the position information and direction information of the ego vehicle at each time. The size of the point set (the number of elements in the point set) is determined based on the length of the prediction time window and the length of the prediction time interval. For example, if the length of the prediction time window is 4 seconds and the length of the prediction time interval is 0.1 seconds, the point set contains 41 elements (=4 s/0.1 s+1). Each point (element) included in the point set represents the position and direction information of the ego vehicle at each time. For example, each point may be expressed as X_{ego,t}, Y_{ego,t}, and θ_{ego,t}. In this example, X_{ego,t} and Y_{ego,t} are the position of the ego vehicle at time t seconds later in the ego coordinate at the current time, and θ_{ego,t} is the heading angle of the ego vehicle at time t seconds later in the ego coordinate at the current time.

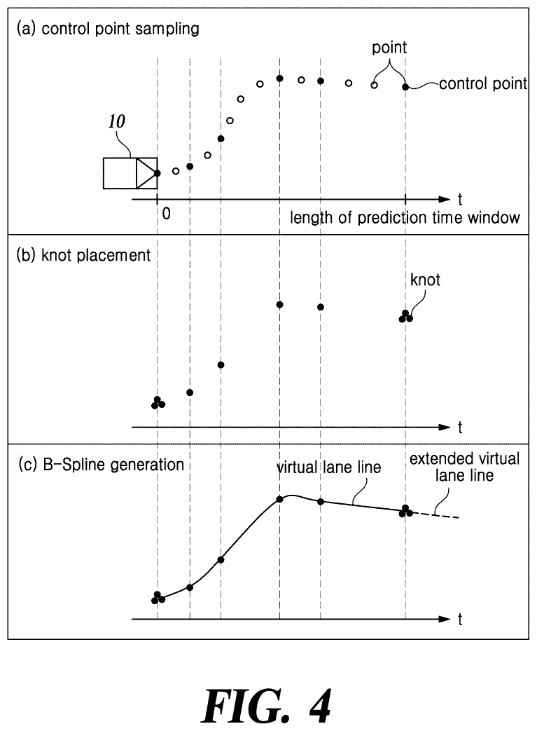

FIG. 4 is a diagram illustrating an example of a method in which the path generating device 100 generates the virtual lane using the predicted path of the ego vehicle 10.

The (a) section of FIG. 4 shows an example of control points sampled from the predicted path point set of the ego vehicle 10. Each point of the (a) section of FIG. 4 represents a point at each predicted time included in the predicted path point set of the ego vehicle 10. Black points are points that are selected as control points, while white points are points that are not selected as control points.

The path generating device 100 performs point sampling on the predicted path point set of the ego vehicle 10 to select multiple control points. The path generating device 100 may perform point sampling at equal or random intervals. In particular, the path generating device 100 may perform sampling in consideration of the shape of the predicted path. For example, the path generating device 100 may sample points on an inflection point or curve in the predicted path of the ego vehicle 10 (e.g., points where dX_{ego,t} and dY_{ego,t} are greater than a predetermined value, among the points included in the predicted path point set).

By generating the virtual lane using only some points among multiple points included in the point set, the memory usage and computational amount for target path prediction may be reduced.

The (b) section of FIG. 4 shows an example of knots that are disposed respectively on a plurality of control points to generate a spline curve. The spline curve is a smooth curve determined by a number of given control points and knots and defines the curve using a separate polynomial for each section (between two adjacent knots). Hereinafter, as an example, the path generating device 100 is described as generating a B-spline curve. However, without being limited thereto, the spline curve may be another spline curve such as a Hermite spline. Further, the B-spline curve may be, but is not limited to, a cubic B-spline curve.

The path generating device 100 places one or more knots on each of the plurality of control points to generate the B-spline curve. In the (b) section of FIG. 4, black dots represent knots that are disposed on the plurality of control points, respectively.

The path generating device 100 may place multiple knots on a first control point and a last control point to generate the B-spline curve passing through the first control point and the last control point. Generally, the B-spline curve does not pass through the control point, but the B-spline curve passing through the control point may be created by placing multiple knots on the control point. Since the Hermit spline curve necessarily passes through the control point, it is unnecessary to place multiple knots on the first and last control points when creating the Hermit spline curve in other embodiments.

The (c) section of FIG. 4 shows an example of the spline curve generated based on multiple knots.

The path generating device 100 generates the B-spline curve based on the multiple knots. A method for generating the B-spline curve when multiple control points and multiple knots are given is widely known in the art to which the present disclosure pertains, so a detailed description thereof is omitted. Hereinafter, the B-spline curve generated by the path generating device 100 may be expressed as Xₗᵢₙₑ(t) and Yₗᵢₙₑ(t) on the ego coordinate using a parameter t. In this example, (Xₗᵢₙₑ(t), Yₗᵢₙₑ(t)) represents a point on the B-spline curve at time t.

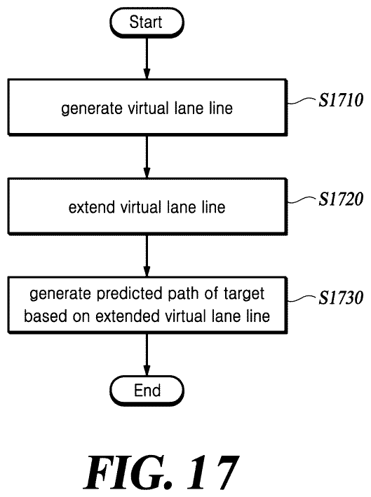

In an additional embodiment, the path generating device 100 may extend (expand) the virtual lane by extrapolating the spline curve. The (c) section of FIG. 4 shows an example of the virtual lane (indicated by a dotted line) that extends outside the prediction time window of the ego vehicle. The path generating device 100 may predict the target path over a wider section by extending the virtual lane from the start point and/or end point of the virtual lane. The extension of the virtual lane is described in more detail below with reference to FIGS. 17-21.

The path generating device 100 predicts the path of the target using the B-spline curve generated based on the predicted path of the ego vehicle as the virtual lane, in step S240.

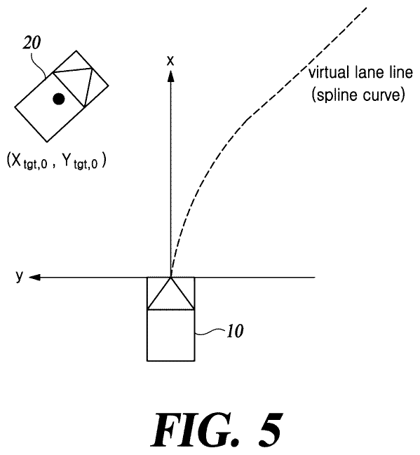

FIGS. 5-13 are diagrams illustrating a process in which the path generating device 100 predicts the path of the target 20 using the virtual lane.

FIG. 5 shows an example of a situation in which the path generating device 100 predicts the path of the target 20. In FIG. 5, (X_{tgt,0}, Y_{tgt,0}) represents the current position of the target 20, and the dotted line represents the virtual lane generated based on the predicted path of the ego vehicle 10.

For convenience of explanation, the length of the prediction time window of the ego vehicle 10 in this example is set to 4 seconds, and the length of the prediction interval is set to 1 second. Thus, the path generating device 100 generates the predicted path of the target 20 from the current time (t=0) to a maximum of 4 seconds (t=4). The predicted path of the target 20 may be expressed as a set of points including the position information and direction information of the target 20 at each time. In this example, the point set of the target 20 may include up to five points (current time, 1 second later, 2 seconds later, 3 seconds later, and 4 seconds later).

The path generating device 100 calculates the parameter tₘᵢₙ of a point where the distance from the virtual lane (Xₗᵢₙₑ(t), Yₗᵢₙₑ(t)) to the current position (X_{tgt,0}, Y_{tgt,0}) of the target 20 is minimum and the normal vector points toward the target 20. In an embodiment, the path generating device 100 may numerically obtain the parameter tₘᵢₙ using the Newton-Raphson method, without being limited thereto. Because the process of calculating the minimum distance from a specific point on a specific curve and its parameter value using the Newton-Raphson method is already known, a detailed description thereof is omitted.

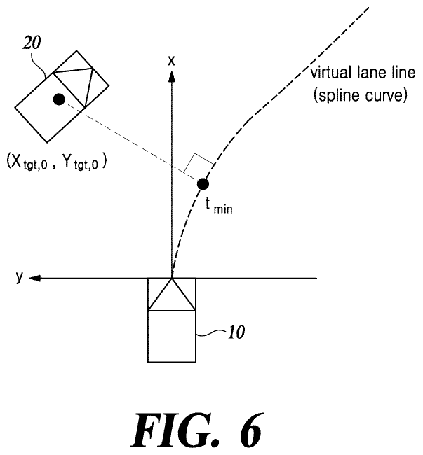

FIG. 6 is a diagram showing the parameter tₘᵢₙ of the virtual lane calculated using the Newton-Raphson method on the virtual lane.

The path generating device 100 calculates the travel direction of the virtual lane, i.e., the direction angle of the tangent vector of the spline curve, at point (Xₗᵢₙₑ(tₘᵢₙ), Yₗᵢₙₑ(tₘᵢₙ)). Equation 2 is an equation for calculating the direction angle θₗᵢₙₑ of the tangent vector of the spline curve at point (Xₗᵢₙₑ(tₘᵢₙ), Yₗᵢₙₑ(tₘᵢₙ)).

$${θ}_{line} = {tan}^{- 1} ( \frac{{dY}_{line} / dt}{{dX}_{line} / dt} ) {\vert}_{t = {t}_{min}} \qquad [ Equation 2 ]$$

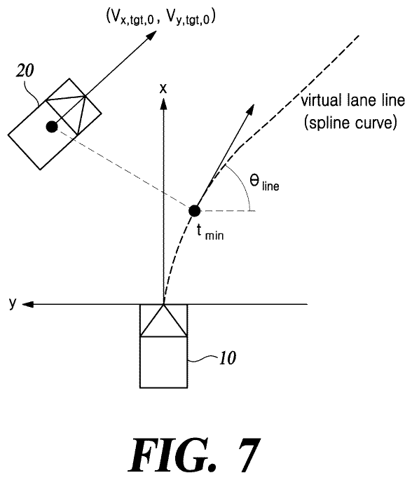

FIG. 7 is a diagram showing the travel direction θₗᵢₙₑ of the virtual lane and the speed (V_{x,tgt,0}, V_{y,tgt,0}) of the target 20 calculated using Equation 2 in FIG. 6.

The path generating device 100 converts the speed (V_{x,tgt,0}, V_{y,tgt,0}) of the target 20 in the ego coordinate into the speed (V_{S,tgt,0}, V_{N,tgt,0}) of the target 20 in the spline coordinate using the travel direction θₗᵢₙₑ of the virtual lane. In the present disclosure, the spline coordinate is a curvilinear coordinate, in which the S-axis represents the length of the spline curve (the length in the tangential direction) and the N-axis represents the normal distance from the spline curve. Hereinafter, the spline coordinate may also be referred to as the S-N coordinate.

Equation 3 is an equation for calculating the target's driving speed (V_{S,tgt}, V_{N,tgt}) in the spline coordinate. In Equation 3, V_{x,tgt}, V_{y,tgt} may be the absolute speed of the target in the ego coordinate.

$$\{ \begin{matrix}{V}_{S , tgt} = {V}_{x , tgt} cos ( {θ}_{line} ) + {V}_{y , tgt} sin ( {θ}_{line} ) \\ {V}_{N , tgt} = {V}_{y , tgt} cos ( {θ}_{line} ) - {V}_{x , tgt} sin ( {θ}_{line} )\end{matrix} \qquad [ Equation 3 ]$$

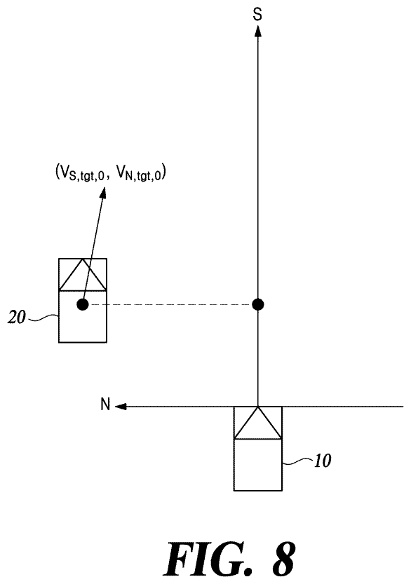

FIG. 8 is a diagram showing the driving situation of FIG. 7 in the spline coordinate. In the spline coordinate of FIG. 8, the origin is located at the front of the ego vehicle 10, the S-axis represents the length of the virtual lane, and the N-axis represents the normal distance from the virtual lane.

The path generating device 100 generates a lateral speed profile and a longitudinal speed profile based on the current speed (V_{S,tgt,0}, V_{N,tgt,0}) of the target 20. In this example, the speed profile means a sequence of speed values representing speed values at each time within the prediction time window (e.g., 0 s˜4 s).

The path generating device 100 generates the lateral speed profile of the target 20 based on the assumption that the target 20 drives parallel to the virtual lane over time, unless there are special circumstances. In other words, the path generating device 100 assumes that the lateral distance N_{tgt} of the target 20 in the spline coordinate converges to a constant value over time, which means that the lateral speed V_{N,tgt} of the target 20 converges to 0.

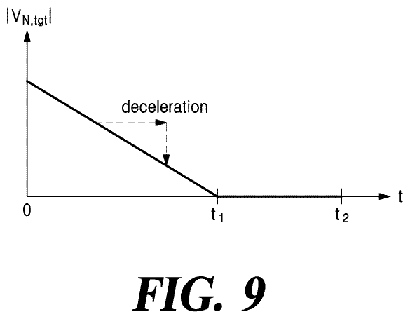

FIG. 9 shows an example of the lateral speed profile of the target 20. In FIG. 9, the horizontal axis represents time and the vertical axis represents the magnitude of the lateral speed. The path generating device 100 generates the lateral speed profile of the target 20 for the prediction time window (0≤t≤t₂) from the current time.

The path generating device 100 may generate a profile in which the lateral speed magnitude |V_{N,tgt}| of the target 20 decreases, reflecting the assumption that the target 20 gradually drives parallel to the virtual lane. In this example, the magnitude of the deceleration may be fixed or adjusted depending on the driving conditions. For example, the magnitude of the deceleration may be, but is not limited to, 0.5 m/s², which is the deceleration in normal driving conditions. In the example of FIG. 9, the lateral speed of the target 20 decreases until time t₁ and then becomes 0 m/s² from time t₁. This means a scenario where the target 20 initially drives in a direction closer to or further away from the virtual lane and then drives parallel to the virtual lane from time t₁.

The longitudinal speed profile of the target 20 may be determined based on the driving conditions of the target 20. For example, when the path generating device 100 detects the brake light of the target 20, it may generate a deceleration profile in which the longitudinal speed of the target 20 decreases.

The path generating device 100 predicts the path of the target 20 based on the lateral speed profile, longitudinal speed profile, and virtual lane of the target 20. In other words, the path generating device 100 generates a set of predicted path points of the target 20.

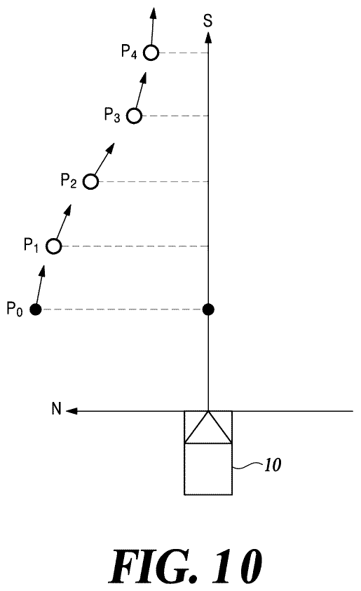

FIG. 10 is a diagram showing points P₀ to P₄ included in the predicted path point set of the target 20 generated by the path generating device 100 of FIG. 9 on the spline coordinate of FIG. 8.

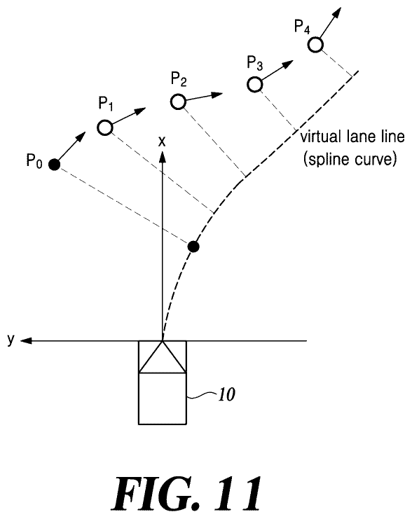

FIG. 11 is a diagram showing the predicted path points P₀ to P₄ of the target 20 indicated on the spline coordinate of FIG. 10 on the ego coordinate of FIG. 7.

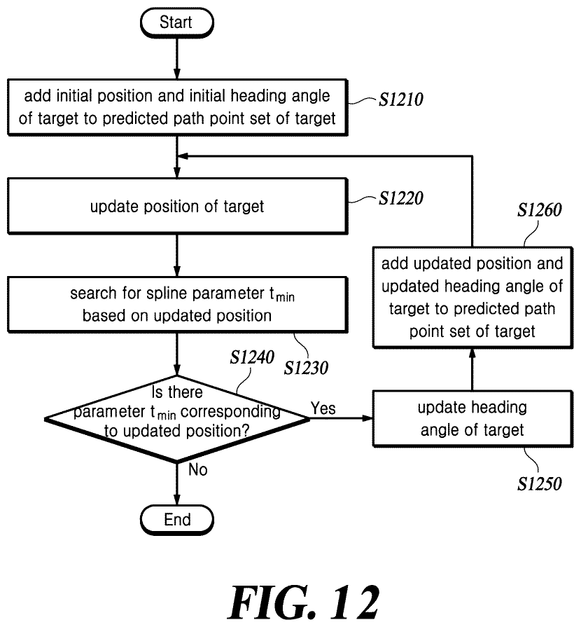

FIG. 12 is an example for explaining a process in which the path generating device 100 according to an embodiment of the present disclosure generates the predicted path of the target 20 using the lateral speed profile, the longitudinal speed profile, and the virtual lane of the target 20.

The path generating device 100 adds point P₀, which represents the position and heading angle (X_{tgt,0}, Y_{tgt,0}, θ_{tgt,0}) of the target 20 at the current time, to the predicted path point set of the target 20, in step S1210.

The path generating device 100 calculates the position of the target 20 at the next time using the position, speed, and heading angle of the target 20 at the current time based on the ego coordinate, in step S1220. Equation 4 is an equation for calculating the next position of the target 20.

$$\{ \begin{matrix}{X}_{tgt , t + 1} = {X}_{tgt , t} + \vert {V}_{tgt , t} \vert \cdot Δ t \cdot cos {θ}_{tgt , t} \\ {Y}_{tgt , t + 1} = {Y}_{tgt , t} + \vert {V}_{tgt , t} \vert \cdot Δ t \cdot sin {θ}_{tgt , t}\end{matrix} \qquad [ Equation 4 ]$$

In Equation 4, (X_{tgt,t}, Y_{tgt,t}) represents the position of the target 20 at time t, |V_{tgt,t}| represents the speed of the target 20 at time t, θ_{tgt,t} represents the heading angle of the target 20 at time t, and At is the magnitude of the prediction interval.

The path generating device 100 recalculates the parameter tₘᵢₙ of the point where the distance from the target 20 to the virtual lane is minimum and the normal vector points toward the target 20, based on the next position (X_{tgt,t+1}, Y_{tgt,t+1}) of the target 20, in step S1230.

The path generating device 100 determines whether the parameter tₘᵢₙ corresponding to the next position of the target 20 exists on the virtual lane, in step S1240. If the parameter tₘᵢₙ corresponding to the next position of the target 20 does not exist on the virtual lane (S1240-NO), the path generating device 100 terminates the generation of the predicted path point set of the target 20.

If the parameter tₘᵢₙ corresponding to the next position of the target 20 exists on the virtual lane (S1240-YES), the path generating device 100 updates tₘᵢₙ and calculates the heading angle of the target 20 at the next time based on the lateral speed profile and the longitudinal speed profile of the target 20, in step S1250.

In detail, the path generating device 100 determines the speed V_{S,tgt,t+1}, V_{N,tgt,t+1} of the target 20 at the next time on the spline coordinate based on the lateral speed profile and the longitudinal speed profile of the target 20. The path generating device 100 calculates the heading angle θ_{tgt,t+1} of the target 20 at the next position on the ego coordinate using the speed V_{S,tgt,t+1}, V_{N,tgt,t+1} of the target 20 and the gradient of the virtual lane point Xₗᵢₙₑ₍ₜₘᵢₙ₎, Yₗᵢₙₑ₍ₜₘᵢₙ₎.

Equation 5 is an equation for calculating the heading angle at the next position of the target 20.

$${θ}_{tgt , t + 1} = {tan}^{- 1} ( \frac{{dY}_{line} / dt}{d {X}_{line} / dt} ) {\vert}_{t = {t}_{min}} + {tan}^{- 1} ( \frac{{V}_{N , tgt , t + 1}}{{V}_{S , tgt , t + 1}} ) \qquad [ Equation 5 ]$$

The path generating device 100 adds point Pₜ₊₁, which represents the updated position and heading angle X_{tgt,t+1}, Y_{tgt,t+1}, θ_{tgt,t+1} of the target 20, to the predicted path point set of the target 20, in step S1260.

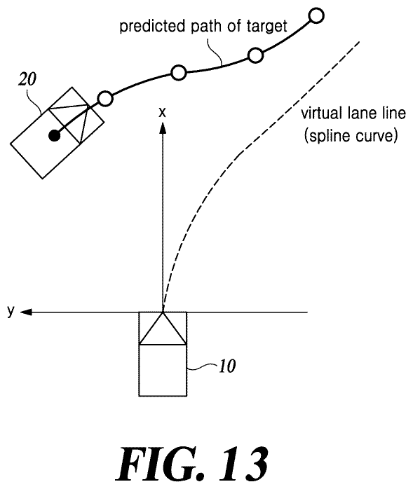

FIG. 13 is a diagram showing the path of the target 20 according to the predicted path points P₀ to P₄ of the target 20 generated by the process of FIG. 12 on the ego coordinate. The autonomous driving system of the ego vehicle 10 may perform path planning and collision avoidance decision, etc. using the path of the target 20 generated according to the present disclosure.

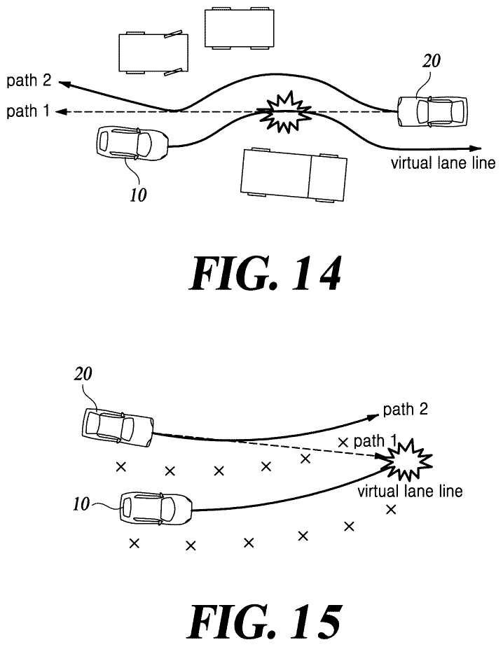

FIGS. 14, 15, and 16 illustrate examples demonstrating improved path prediction performance achieved by a method of the present disclosure. In FIGS. 14, 15, and 16, path 1 represents the predicted path of the target 20 generated by a conventional path prediction method, and path 2 represents the predicted path of the target 20 generated by the method of the present disclosure.

FIG. 14 is a diagram showing an example in which the autonomous driving system of the ego vehicle 10 performs a collision decision on an oncoming target 20 on a narrow road where the ego vehicle 10 may not use lane information.

In a conventional path prediction method, when the lane information is not available, the future path (path 1) of the target 20 is generated assuming that the target 20 is driving straight in the current driving direction. Therefore, referring to FIG. 14, the autonomous driving system determines that the ego vehicle 10 and the target 20 collide at a midpoint. On the other hand, the method of the present disclosure generates the future path (path 2) of the target 20 based on the virtual lane, thereby allowing the autonomous driving system to determine that the ego vehicle 10 and the target 20 do not collide.

FIG. 15 is a diagram showing an example in which the autonomous driving system of the ego vehicle 10 performs a collision decision on the target 20 driving in the same direction in a rainy environment where the ego vehicle 10 may not recognize the lane.

In the conventional path prediction method, when lane recognition is not possible and lane information is not available, the future path (path 1) of the target 20 is generated assuming that the target 20 is driving straight in the current driving direction. Therefore, referring to FIG. 15, the autonomous driving system determines that the ego vehicle 10 and the target 20 collide at the last point of the prediction time window. On the other hand, the method of the present disclosure generates the future path (path 2) of the target 20 based on the virtual lane, thereby allowing the autonomous driving system to determine that the ego vehicle 10 and the target 20 do not collide.

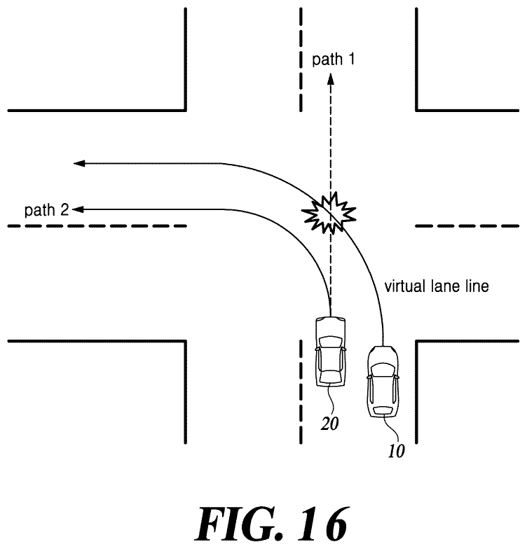

FIG. 16 is a diagram showing an example in which the autonomous driving system of the ego vehicle 10 performs a collision decision on the target 20 in the left turn lane at an intersection without lanes. In FIG. 16, the ego vehicle 10 and the target 20 are driving to make a left turn.

In the conventional path prediction method, when there is no lane and lane information may not be used, the future path (path 1) of the target 20 is generated by assuming that the target 20 is driving straight in the current driving direction. Therefore, referring to FIG. 15, the autonomous driving system determines that the ego vehicle 10 and the target 20 collide in the center of the intersection. On the other hand, the method of the present disclosure generates the future path (path 2) of the target 20 based on the virtual lane, thereby allowing the autonomous driving system to determine that the ego vehicle 10 and the target 20 do not collide.

In an additional embodiment of the present disclosure, the path generating device 100 may expand the prediction time window of the target 20. In other words, the path generating device 100 may extend (expand) the predicted path of the target 20.

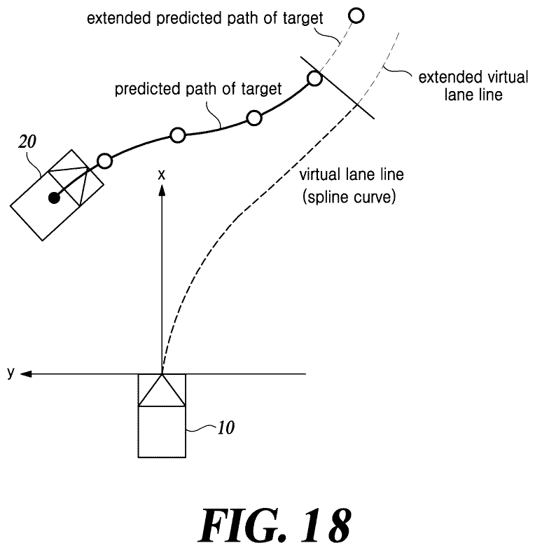

FIG. 17 is a flowchart illustrating a process in which the path generating device 100 extends the predicted path of the target 20. FIG. 18 is a diagram illustrating an example of the extended predicted path of the target 20 generated by the process of FIG. 17, as shown in the example of FIG. 13.

The path generating device 100 generates a virtual lane based on the predicted path point set of the ego vehicle 10, as described with reference to FIG. 4, in step S1710.

The path generating device 100 extends the virtual lane by extrapolating the B-spline curve from the start point and/or the end point of the virtual lane, in step S1720. For example, FIG. 18 illustrates a virtual lane extended by the path generating device 100 extrapolating the B-spline curve from the end point of the virtual lane.

The path generating device 100 generates the predicted path of the target 20 using the extended virtual lane, as described with reference to FIGS. 5-13. The path generating device 100 may predict the path of the target 20 even for a range outside the prediction time window of the ego vehicle 10 by using the extended virtual lane, in step S1730. For example, FIG. 18 illustrates the predicted path of the target 20 generated by the path generating device 100 based on the virtual lane with the extended end point.

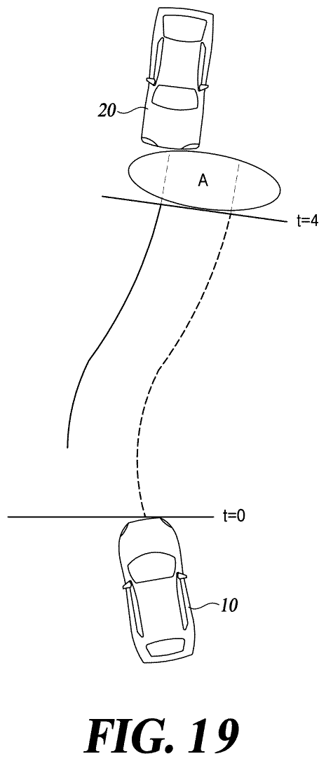

FIGS. 19, 20, and 21 illustrate examples of a situation in which extension of the prediction time window of the target 20 is required according to the present disclosure. In FIGS. 19, 20, and 21, the dashed curves represent the virtual lane, the solid curve represents the predicted path of the target 20 within the prediction time window of the ego vehicle 10, and the dotted curve represents the extended virtual lane or the extended predicted path of the target 20. Further, in FIGS. 19, 20, and 21, horizontal straight lines represent the start point or end point of the prediction time window of the ego vehicle 10.

FIG. 19 is a diagram showing an example in which the target 20 is located farther than the end point of the prediction time window of the ego vehicle 10.

If the target 20 is located farther than the end point of the prediction time window of the ego vehicle 10, the path generating device 100 may not calculate the parameter tₘᵢₙ of the point where the distance from the virtual lane to the current position (X_{tgt,0}, Y_{tgt,0}) of the target 20 is minimum and the normal vector points toward the target 20, so it may not generate the path of the target 20 after the end point of the prediction time window. In this case, the path generating device 100 may generate the path of the target 20 after the end point of the prediction time window by extending the virtual lane by extrapolating the spline curve from the end point of the prediction time window and calculating tₘᵢₙ based on the extended virtual lane.

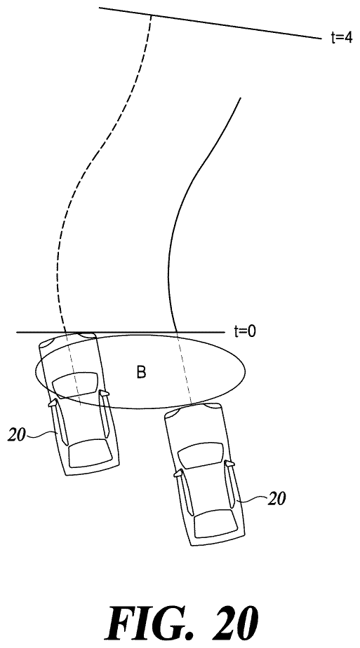

FIG. 20 is a diagram showing an example in which the target 20 is located farther than the start point of the prediction time window of the ego vehicle 10.

If the target 20 is located farther than the start point of the prediction time window of the ego vehicle 10, the path generating device 100 may not calculate the parameter tₘᵢₙ of the point where the distance from the virtual lane to the current position (X_{tgt,0}, Y_{tgt,0}) of the target 20 is minimum and the normal vector points toward the target 20, so it may not generate the path of the target 20 before the start point of the prediction time window. In this case, the path generating device 100 may generate the path of the target 20 before the start point of the prediction time window by extending the virtual lane by extrapolating the spline curve from the start point of the prediction time window and calculating tₘᵢₙ based on the extended virtual lane.

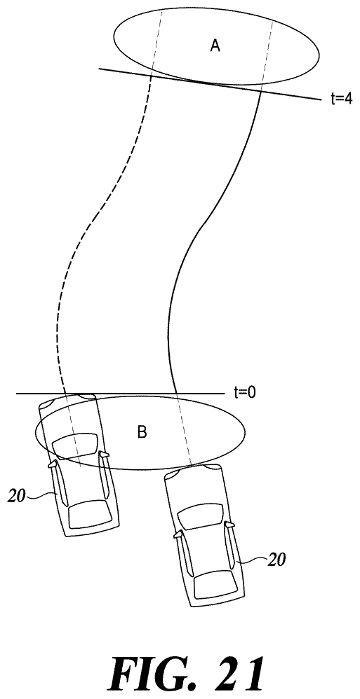

FIG. 21 is a diagram showing another example in which the target 20 is located farther than the start point of the prediction time window of the ego vehicle 10.

The path generating device 100 may also extend both ends of the prediction time window by generating the path of the target 20 after the end point of the prediction time window as described with reference to FIG. 19 and generating the path of the target 20 before the start point of the prediction time window as described with reference to FIG. 20.

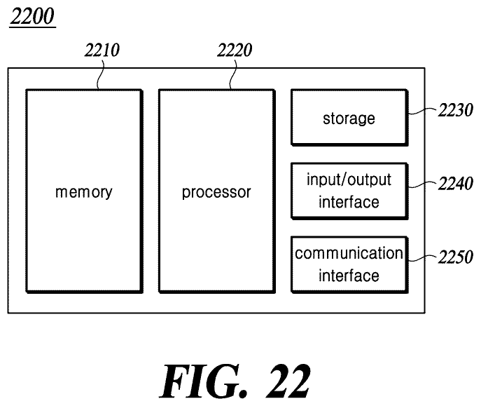

FIG. 22 is a block diagram schematically illustrating a computing device that may be used to implement a method or apparatus according to the present disclosure.

The computing device 2200 may include some or all of a memory 2210, a processor 2220, a storage 2230, an input/output interface 2240, or a communication interface 2250. The computing device 2200 may structurally and/or functionally include at least a portion of the apparatus according to the present disclosure. The computing device 2200 may be a stationary computing device such as a desktop computer or a server as well as a mobile computing device such as a laptop computer, a smart phone, or a vehicle electronic component. The computing device 2200 may be implemented as any specialized hardware accelerator capable of processing operations for an artificial intelligence model in an efficient manner. For example, the computing device 2200 may include a graphic processing unit (GPU), a tensor processing unit (TPU), or a neural processing unit (NPU).

The memory 2210 may store a program that causes the processor 2220 to perform methods or operations according to various embodiments of the present disclosure. For example, the program may include a plurality of commands executable by the processor 2220, and the above-described method or operations may be performed by executing the plurality of commands through the processor 2220. The memory 2210 may be a single memory or multiple memories. In this case, information required to perform the method or operation according to various embodiments of the present disclosure may be stored in the single memory or divided and stored in the multiple memories. When the memory 2210 comprises multiple memories, the multiple memories may be physically separated. The memory 2210 may include at least one of volatile memory or non-volatile memory. The volatile memory includes SRAM (Static Random Access Memory) or DRAM (Dynamic Random Access Memory), and the nonvolatile memory includes flash memory.

The processor 2220 may include at least one core capable of executing at least one command. The processor 2220 may execute commands stored in the memory 2210. The processor 2220 may be a single processor or multiple processors.

The storage 2230 maintains stored data even when power supplied to the computing device 2200 is cut off. For example, the storage 2230 may include the non-volatile memory and may include storage media such as magnetic tape, optical disks, or magnetic disks. A program stored in the storage 2230 may be loaded into the memory 2210 before being executed by the processor 2220. The storage 2230 may store a file written in a programming language, and a program generated from the file by a compiler or the like may be loaded into the memory 2210. The storage 2230 may store data to be processed by the processor 2220 and/or data processed by the processor 2220.

The input/output interface 2240 may provide an interface with an input device such as a keyboard or a mouse, and/or an output device such as a display device or a printer. A user may trigger execution of a program by the processor 2220 through the input device and/or check the processing result of the processor 2220 through the output device.

The communication interface 2250 may provide access to an external network. The computing device 2200 may communicate with other devices through the communication interface 2250.

Each element of the apparatus or method in accordance with the present disclosure may be implemented in hardware or software, or a combination of hardware and software. The functions of the respective elements may be implemented in software, and a microprocessor may be implemented to execute the software functions corresponding to the respective elements.

Various embodiments of systems and techniques described herein can be realized with digital electronic circuits, integrated circuits, field programmable gate arrays (FPGAs), application specific integrated circuits (ASICs), computer hardware, firmware, software, and/or combinations thereof. The various embodiments can include implementation with one or more computer programs that are executable on a programmable system. The programmable system includes at least one programmable processor, which may be a special purpose processor or a general purpose processor, coupled to receive and transmit data and instructions from and to a storage system, at least one input device, and at least one output device. Computer programs (also known as programs, software, software applications, or code) include instructions for a programmable processor and are stored in a “computer-readable recording medium.”

The computer-readable recording medium may include all types of storage devices on which computer-readable data can be stored. The computer-readable recording medium may be a non-volatile or non-transitory medium, such as a read-only memory (ROM), a random access memory (RAM), a compact disc ROM (CD-ROM), magnetic tape, a floppy disk, or an optical data storage device. In addition, the computer-readable recording medium may further include a transitory medium such as a data transmission medium. Furthermore, the computer-readable recording medium may be distributed over computer systems connected through a network, and computer-readable program code can be stored and executed in a distributive manner.

Although operations are illustrated in the flowcharts/timing charts in the present disclosure as being sequentially performed, this is merely a description of the technical idea of the present disclosure. In other words, those having ordinary skill in the art to which the present disclosure belongs may appreciate that various modifications and changes can be made without departing from essential features of the present disclosure, i.e., the sequence illustrated in the flowcharts/timing charts can be changed and one or more operations of the operations can be performed in parallel. Thus, flowcharts/timing charts are not limited to the temporal order.

Although embodiments of the present disclosure have been described for illustrative purposes, those having ordinary skill in the art should appreciate that various modifications, additions, and substitutions are possible, without departing from the idea and scope of the present disclosure. Therefore, embodiments of the present disclosure have been described for the sake of brevity and clarity. The scope of the technical idea of the present disclosure is not limited by the illustrations. Accordingly, those of ordinary skill in the art should understand that the scope of the present disclosure should not be limited by the above explicitly described embodiments but by the claims and equivalents thereof.

What is claimed is:

1. A method for predicting a path of a target, the method comprising:
receiving driving information of an ego vehicle, driving information of the target, and a predicted path of the ego vehicle, wherein the predicted path of the ego vehicle is a sequence of points representing positions and directions of the ego vehicle at each prediction time;
determining whether the target is driving relative to a path of the ego vehicle based on the driving information of the ego vehicle and the target;
generating a virtual lane based on the predicted path of the ego vehicle; and
generating a predicted path of the target based on the virtual lane.

2. The method of claim 1, wherein the driving information of the target comprises a position, a speed, and a direction of the target, and
wherein determining whether the target is driving relative to the path of the ego vehicle comprises:
determining whether a tracking time for the target is equal to or greater than a predetermined time;
determining whether an amount of change in a lateral distance between the target and the ego vehicle is equal to or less than a first predetermined amount; and
determining whether an amount of change in a heading angle of the target is equal to or less than a second predetermined amount.

3. The method of claim 2, wherein the driving information of the ego vehicle comprises a steering angle and a yaw rate of the ego vehicle, and
wherein the lateral distance between the target and the ego vehicle is a shortest distance from a turning path of the ego vehicle to the target, calculated based on the steering angle and the yaw rate of the ego vehicle.

4. The method of claim 2, wherein the amount of change in the lateral distance and the amount of change in the heading angle are denoising filtered values, and
wherein the denoising filtering is low-pass filtering or moving average filtering.

5. The method of claim 1, wherein generating the virtual lane comprises generating a spline curve representing the virtual lane based on a plurality of points in the predicted path of the ego vehicle.

6. The method of claim 1, wherein generating the virtual lane comprises:
selecting a plurality of control points from a plurality of points in the predicted path of the ego vehicle to generate a sequence of control points; and
generating a spline curve representing the virtual lane based on the sequence of control points.

7. The method of claim 6, wherein the spline curve is a B-spline curve, and
wherein generating the spline curve comprises:
placing at least one knot on each of the plurality of control points; and
generating the B-spline curve based on the sequence of control points and knots.

8. The method of claim 7, wherein a plurality of knots is disposed on each of a first control point and a last control point in the sequence of control points, and
wherein one knot is disposed on each of remaining control points in the sequence of control points.

9. The method of claim 1, wherein generating the predicted path of the target comprises:
determining a point on the virtual lane corresponding to a current position of the target, wherein a distance from the point on the virtual lane to the target is minimum distance from the virtual lane to the target;
determining a current speed of the target in a spline coordinate based on a direction of the virtual lane at the point on the virtual lane and a current speed of the target, wherein an S-axis on the spline coordinate represents a length of the virtual lane and an N-axis on the spline coordinate represents a normal distance from the virtual lane;
generating a lateral speed profile and a longitudinal speed profile of the target in the spline coordinate, wherein a lateral speed of the target in the lateral speed profile converges to 0; and
generating predicted path of the target based on the lateral speed profile, the longitudinal speed profile, and the virtual lane.

10. The method of claim 9, wherein generating the predicted path of the target based on the lateral speed profile, the longitudinal speed profile, and the virtual lane comprises:
(a) adding a point representing the position and heading angle of the target at current time to a path prediction point set of the target;
(b) calculating a position of the target at next time point based on a previous point and heading angle of the target;
(c) calculating a point on the virtual lane corresponding to the position of the target at the next time point;
(d) calculating a heading angle of the target at the next time point based on the lateral speed profile and the longitudinal speed profile;
(e) adding a point representing the position and the heading angle of the target at the next time point to the path prediction point set of the target; and
(f) repeating the steps (b), (c), (d) and (e) until calculating a point on the virtual lane corresponding to the position of the target at the next time point is unable.

11. The method of claim 5, wherein generating the virtual lane comprises:
extending the virtual lane by extrapolating the spline curve from at least one of a start point or an end point of the spline curve.

12. An apparatus for predicting a path of a target, the apparatus comprising:
at least one memory configured to store commands; and
at least one processor, by executing the commands, configured to:
receive driving information of an ego vehicle, driving information of the target, and a predicted path of the ego vehicle, wherein the predicted path of the ego vehicle is a sequence of points representing positions and directions of the ego vehicle at each prediction time;
determine whether the target is driving relative to a path of the ego vehicle based on the driving information of the ego vehicle and the target;
generate a virtual lane based on the predicted path of the ego vehicle; and
generate a predicted path of the target based on the virtual lane.
